(19) United States
(12) Patent Application Publication
(10) Pub. No.: US 2006/0036438 A1
(43) Pub. Date: Feb. 16, 2006

(54) Efficient multimodal method to provide input to a computing device

(75) Inventor: Eric I-Chao Chang, Beijing (CN)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/889,822

(22) Filed: Jul. 13, 2004

(51) Int. Cl. G10L 15/26

(52) U.S. Cl. 704/235

(57) ABSTRACT

A method and system for providing input into a computer includes receiving input speech from a user and providing data corresponding to the input speech. The data is used to search a collection of phrases and identify one or more phrases from the collection having a relation to the data. The one or more phrases are visually rendered to the user. An indication is received of a selection from the user of one of the phrases and the selected phrase is provided to an application operating on the computing device.

### BACKGROUND OF THE INVENTION

The present invention relates to providing input into a computing device. More particularly, the present invention relates to a multimodal method of providing input that includes speech recognition and identification of desired input from a set of alternatives to improve efficiency.

Small computing devices such as personal information managers (PIM), devices and portable phones are used with ever increasing frequency by people in their day-to-day activities. With the increase in processing power now available for microprocessors used to run these devices, the functionality of these devices are increasing, and in some cases, merging. For instance, many portable phones now can be used to access and browse the Internet as well as can be used to store personal information such as addresses, phone numbers and the like.

In view that these computing devices are being used for ever increasing tasks, it is therefore necessary to enter information into the computing device easily and efficiently. Unfortunately, due to the desire to keep these devices as small as possible in order that they are easily carried, conventional keyboards having all the letters of the alphabet as isolated buttons are usually not possible due to the limited surface area available on the housings of the computing devices. Likewise, handwriting recognition requires a pad or display having an area convenient for entry of characters, which can increase the overall size of the computing device. Moreover though, handwriting recognition is a generally slow input methodology.

There is thus an ongoing need to improve upon the manner in which data, commands and the like are entered into computing devices. Such improvements would allow convenient data entry for small computing devices such as PIMs, telephones and the like, and can further be useful in other computing devices such as personal computers, televisions, etc.

### SUMMARY OF THE INVENTION

A method and system for providing input into a computer includes receiving input speech from a user and providing data corresponding to the input speech. The data is used to search a collection of phrases and identify one or more phrases from the collection having a relation to the data. The one or more phrases are visually rendered to the user. An indication is received of a selection from the user of one of the phrases and the selected phrase is provided to an application operating on the computing device.

The combined use of speech input and selection of visually rendered possible phrases provides an efficient method for users to access information, particularly on a mobile computing device where hand manipulated input devices are difficult to implement. By allowing the user to provide an audible search query, the user can quickly provide search terms, which can be used to search a comprehensive collection of possible phrases the user would like to input. In addition, since the user can easily scan a visually rendered list of possible phrases, the user can quickly find the desired phrase, and using for example a pointing device, select the phrase that is then used as input for an application executing on the computing device.

### BRIEF DESCRIPTION OF THE DRAWINGS

FIG. 1 is a plan view of a first embodiment of a computing device operating environment.

FIG. 2 is a block diagram of the computing device of FIG. 1.

FIG. 3 is a block diagram of a general purpose computer.

FIG. 4 is a block diagram of a data entry system.

FIG. 5 is a representation of a lattice.

FIG. 6 is a flow diagram of a method for providing input in a computer system.

### DETAILED DESCRIPTION OF THE ILLUSTRATIVE EMBODIMENTS

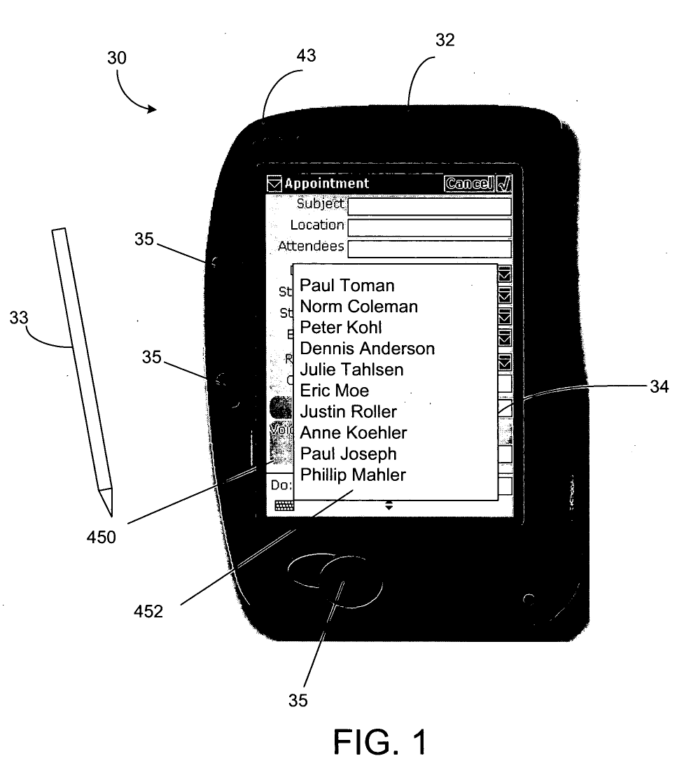

Before describing aspects of the present invention, it may be useful to describe generally computing devices that can incorporate and benefit from these aspects. Referring now to FIG. 1, an exemplary form of a data management device (PIM, PDA or the like) is illustrated at 30. However, it is contemplated that the present invention can also be practiced using other computing devices discussed below, and in particular, those computing devices having limited surface areas for input buttons or the like. For example, phones and/or data management devices will also benefit from the present invention. Such devices will have an enhanced utility compared to existing portable personal information management devices and other portable electronic devices, and the functions and compact size of such devices will more likely encourage the user to carry the device at all times. Accordingly, it is not intended that aspects of the present invention herein described be limited by the disclosure of an exemplary data management or PIM device, phone or computer herein illustrated.

An exemplary form of a data management mobile device 30 is illustrated in FIG. 1. The mobile device 30 includes a housing 32 and has a user interface including a display 34, which uses a contact sensitive display screen in conjunction with a stylus 33. The stylus 33 is used to press or contact the display 34 at designated coordinates to select a field, to selectively move a starting position of a cursor, or to otherwise provide command information such as through gestures or handwriting. Alternatively, or in addition, one or more buttons 35 can be included on the device 30 for navigation. In addition, other input mechanisms such as rotatable wheels, rollers or the like can also be provided. However, it should be noted that the invention is not intended to be limited by these forms of input mechanisms. For instance, another form of input can include a visual input such as through computer vision.

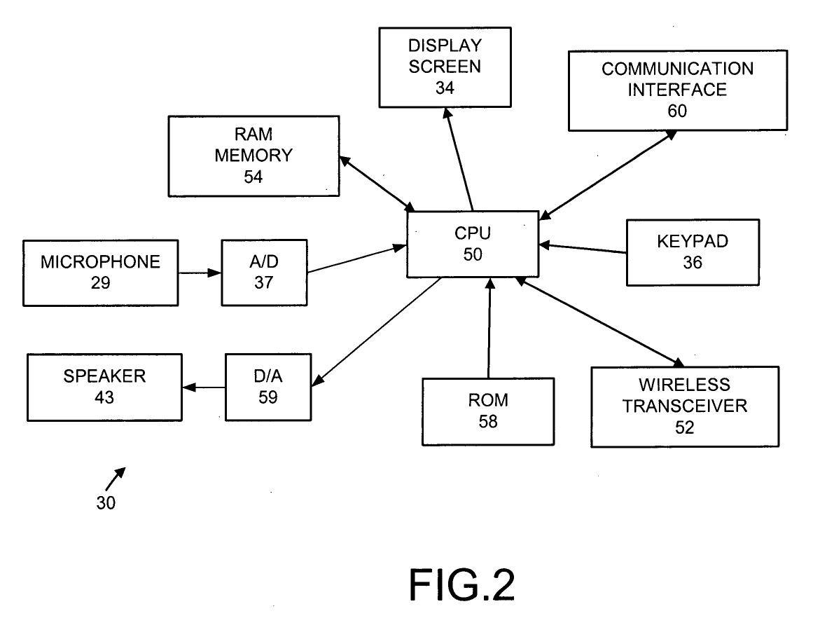

Referring now to FIG. 2, a block diagram illustrates the functional components comprising the mobile device 30. A central processing unit (CPU) 50 implements the software control functions. CPU 50 is coupled to display 34 so that text and graphic icons generated in accordance with the controlling software appear on the display 34. A speaker 43 can be coupled to CPU 50 typically with a digital-to-analog converter 59 to provide an audible output. Data that is downloaded or entered by the user into the mobile device 30 is stored in a non-volatile read/write random access memory store 54 bi-directionally coupled to the CPU 50. Random access memory (RAM) 54 provides volatile storage for instructions that are executed by CPU 50, and storage for temporary data, such as register values. Default values for configuration options and other variables are stored in a read only memory (ROM) 58. ROM 58 can also be used to store the operating system software for the device that controls the basic functionality of the mobile 30 and other operating system kernel functions (e.g., the loading of software components into RAM 54).

RAM 54 also serves as a storage for the code in the manner analogous to the function of a hard drive on a PC that is used to store application programs. It should be noted that although non-volatile memory is used for storing the code, it alternatively can be stored in volatile memory that is not used for execution of the code.

Wireless signals can be transmitted/received by the mobile device through a wireless transceiver 52, which is coupled to CPU 50. An optional communication interface 60 can also be provided for downloading data directly from a computer (e.g., desktop computer), or from a wired network, if desired. Accordingly, interface 60 can comprise various forms of communication devices, for example, an infrared link, modem, a network card, or the like.

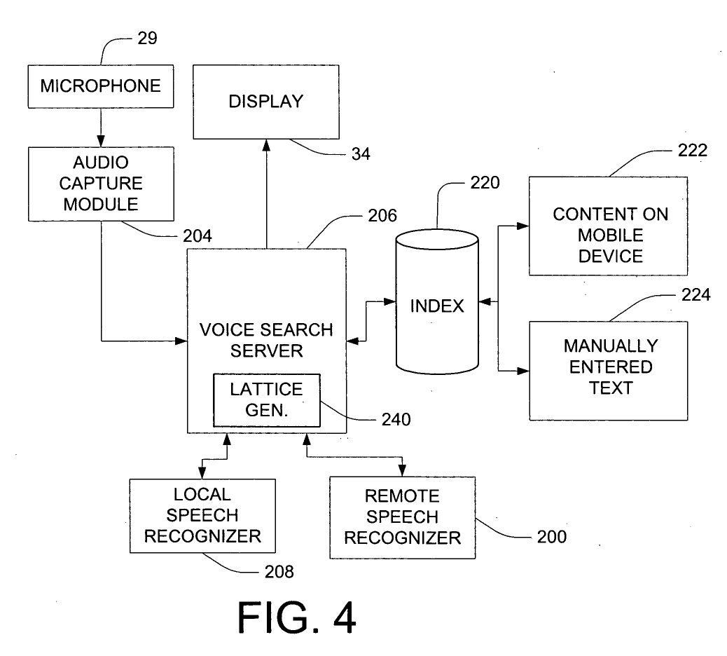

Mobile device 30 includes a microphone 29, and analog-to-digital (A/D) converter 37, and an optional recognition program (speech, DTMF, handwriting, gesture or computer vision) stored in store 54. By way of example, in response to audible information, instructions or commands from a user of device 30, microphone 29 provides speech signals, which are digitized by A/D converter 37. The speech recognition program can perform normalization and/or feature extraction functions on the digitized speech signals to obtain intermediate speech recognition results. Speech recognition can be performed on mobile device 30 and/or using wireless transceiver 52 or communication interface 60, speech data can be transmitted to a remote recognition server 200 over a local or wide area network, including the Internet as illustrated in FIG. 4.

In addition to the portable or mobile computing devices described above, it should also be understood that the present invention can be used with numerous other computing devices such as a general desktop computer. For instance, the present invention will allow a user with limited physical abilities to input or enter text into a computer or other computing device when other conventional input devices, such as a full alpha-numeric keyboard, are too difficult to operate.

The invention is also operational with numerous other general purpose or special purpose computing systems, environments or configurations. Examples of well known computing systems, environments, and/or configurations that may be suitable for use with the invention include, but are not limited to, regular telephones (without any screen) personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

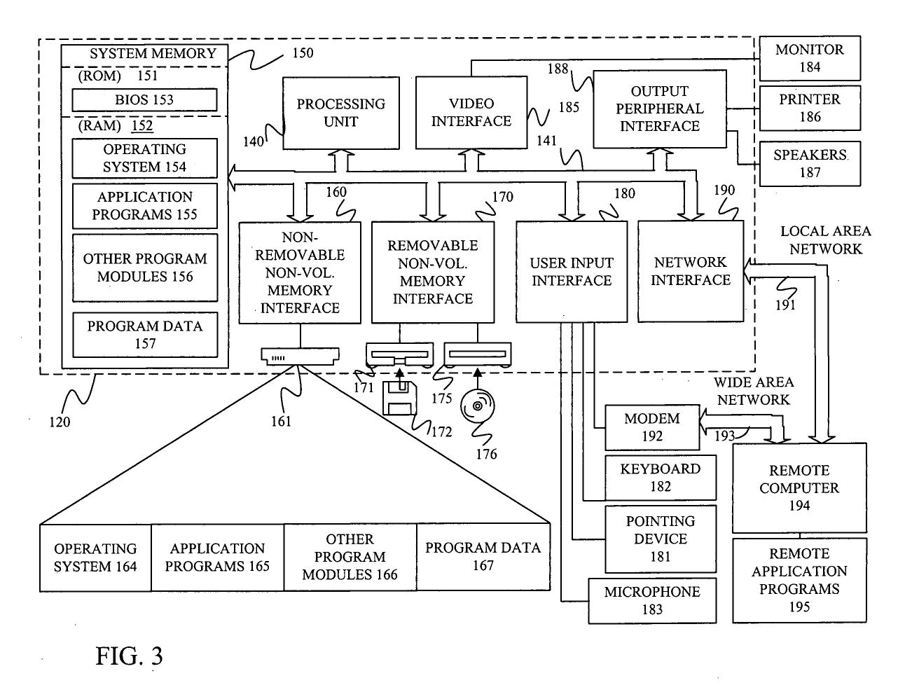

The following is a brief description of a general purpose computer 120 illustrated in FIG. 3. However, the computer 120 is again only one example of a suitable computing environment and is not intended to suggest any limitation as to the scope of use or functionality of the invention. Neither should the computer 120 be interpreted as having any dependency or requirement relating to any one or combination of components illustrated therein.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 3, components of computer 120 may include, but are not limited to, a processing unit 140, a system memory 150, and a system bus 141 that couples various system components including the system memory to the processing unit 140. The system bus 141 may be any of several types of bus structures including a memory bus or memory controller, a peripheral bus, and a local bus using any of a variety of bus architectures. By way of example, and not limitation, such architectures include Industry Standard Architecture (ISA) bus, Universal Serial Bus (USB), Micro Channel Architecture (MCA) bus, Enhanced ISA (EISA) bus, Video Electronics Standards Association (VESA) local bus, and Peripheral Component Interconnect (PCI) bus also known as Mezzanine bus. Computer 120 typically includes a variety of computer readable mediums. Computer readable mediums can be any available media that can be accessed by computer 120 and includes both volatile and nonvolatile media, removable and non-removable media. By way of example, and not limitation, computer readable mediums may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 120.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 150 includes computer storage media in the form of volatile and/or nonvolatile memory such as read only memory (ROM) 151 and random access memory (RAM) 152. A basic input/output system 153 (BIOS), containing the basic routines that help to transfer information between elements within computer 120, such as during start-up, is typically stored in ROM 151. RAM 152 typically contains data and/or program modules that are immediately accessible to and/or presently being operated on by processing unit 140. By way of example, and not limitation, FIG. 3 illustrates operating system 54, application programs 155, other program modules 156, and program data 157.

The computer 120 may also include other removable/non-removable volatile/nonvolatile computer storage media. By way of example only, FIG. 3 illustrates a hard disk drive 161 that reads from or writes to non-removable, nonvolatile magnetic media, a magnetic disk drive 171 that reads from or writes to a removable, nonvolatile magnetic disk 172, and an optical disk drive 175 that reads from or writes to a removable, nonvolatile optical disk 176 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 161 is typically connected to the system bus 141 through a non-removable memory interface such as interface 160, and magnetic disk drive 171 and optical disk drive 175 are typically connected to the system bus 141 by a removable memory interface, such as interface 170.

The drives and their associated computer storage media discussed above and illustrated in FIG. 3, provide storage of computer readable instructions, data structures, program modules and other data for the computer 120. In FIG. 3, for example, hard disk drive 161 is illustrated as storing operating system 164, application programs 165, other program modules 166, and program data 167. Note that these components can either be the same as or different from operating system 154, application programs 155, other program modules 156, and program data 157. Operating system 164, application programs 165, other program modules 166, and program data 167 are given different numbers here to illustrate that, at a minimum, they are different copies.

A user may enter commands and information into the computer 120 through input devices such as a keyboard 182, a microphone 183, and a pointing device 181, such as a mouse, trackball or touch pad. Other input devices (not shown) may include a joystick, game pad, satellite dish, scanner, or the like. These and other input devices are often connected to the processing unit 140 through a user input interface 180 that is coupled to the system bus, but may be connected by other interface and bus structures, such as a parallel port, game port or a universal serial bus (USB). A monitor 184 or other type of display device is also connected to the system bus 141 via an interface, such as a video interface 185. In addition to the monitor, computers may also include other peripheral output devices such as speakers 187 and printer 186, which may be connected through an output peripheral interface 188.

The computer 120 may operate in a networked environment using logical connections to one or more remote computers, such as a remote computer 194. The remote computer 194 may be a personal computer, a hand-held device, a server, a router, a network PC, a peer device or other common network node, and typically includes many or all of the elements described above relative to the computer 120. The logical connections depicted in FIG. 3 include a local area network (LAN) 191 and a wide area network (WAN) 193, but may also include other networks. Such networking environments are commonplace in offices, enterprise-wide computer networks, intranets and the Internet.

When used in a LAN networking environment, the computer 120 is connected to the LAN 191 through a network interface or adapter 190. When used in a WAN networking environment, the computer 120 typically includes a modem 192 or other means for establishing communications over the WAN 193, such as the Internet. The modem 192, which may be internal or external, may be connected to the system bus 141 via the user input interface 180, or other appropriate mechanism. In a networked environment, program modules depicted relative to the computer 120, or portions thereof, may be stored in the remote memory storage device. By way of example, and not limitation, FIG. 3 illustrates remote application programs 195 as residing on remote computer 194. It will be appreciated that the network connections shown are exemplary and other means of establishing a communications link between the computers may be used.

FIG. 4 schematically illustrates components or modules suitable for implementing aspects of the present invention. On the mobile device 30, by way of example, speech input captured by microphone 29 and suitably processed by an audio capture module 204 is provided to a voice search server 206. For instance, the data can be transmitted to the voice search server 206 in PCM format. The voice search server 206 passes the received speech samples to a local speech recognition module 208 and/or to remote speech recognition server 200. Large vocabulary speech recognition and/or application specific speech recognition can be employed. Likewise, speech recognition can employ phonetic recognition at the phone level, word fragment level or word level. Recognized results are returned back to the voice search server 206. The recognized results are then used by the voice search server 206 to formulate a data query (e.g. pattern) for an information retrieval technique that in turn provides a ranked list of relevant items, for instance text phrases, based on information known to exist on the computing device.

Many known techniques of information retrieval can be used. In one embodiment, to accelerate the retrieval process, an index 220 of information to be searched and possibly retrieved is created. For instance, the index 220 can be based on content 222 available on the computing device (e.g. addresses, appointments, e-mail messages, etc.) as well as input 224 otherwise manually entered into the computing device, herein mobile device 30. Although illustrated wherein the index 220 is illustrated as functioning for both content 222 and input 224, it should be understood that separate indexes can be provided if desired. The use of separate indexes or an index 220 adapted to reference information based on categories allows a user to specify a search in only certain categories of information as may be desired.

Index 220 can take many forms. In one preferred embodiment, index 220 comprises pre-computed phonetic lattices of the words in content 222 and or input 224. Conversion of words in content 222 and input 224 to phonetic lattices is relatively straight forward by referencing a dictionary in order to identify component phonemes and phonetic fragments. Alternatives pronunciations of words can be included in the corresponding lattice such as the word “either”, namely one node of the lattice beginning with the initial pronunciation of “ei” as “i” (as in “like”) and another node beginning with the alternate initial pronunciation of “ei” as “ee” (as in “queen”), both followed by the “ther”. Another example is the word “primer”, which has alternate pronunciations of “prim-er”, with “prim” pronounced similar to “him”, or “pri-mer” with “pri” pronounced similar to “high”.

The voice search server 206 includes a lattice generation module 240 that receives the results from the speech recognizer 200 and/or 208 to identify phonemes and phonetic fragments according to a dictionary. Using the output from speech recognizer 204, lattice generation module 240 constructs a lattice of phonetic hypotheses, wherein each hypothesis includes an associated time boundary and accuracy score.

If desired, approaches can be used to alter the lattice for more accurate and efficient searching. For example, the lattice can be altered to allow crossover between phonetic fragments. Additionally, penalized back-off paths can be added to allow transitions between hypotheses with mismatching paths in the lattice. Thus, output scores can include inconsistent hypotheses. In order to reduce the size of the lattice, hypotheses can be merged to increase the connectivity of phonemes and thus reduce the amount of audio data stored in the lattice.

The speech recognizer 200, 208 operates based upon a dictionary of phonetic word fragments. In one embodiment, the fragments are determined based on a calculation of mutual-information of adjacent units v and w, (which may be phonemes or combinations of phonemes). Mutual information MI can be defined as follows:

$$MI ( v , w ) = log ( \frac{P ( v , w )}{P ( v ) \cdot P ( w )} ) \cdot P ( v , w )$$

Any pairs (v, w) having a MI above a particular threshold can be used as candidates for fragments to be chosen for the dictionary. A pair of units can be eliminated from a candidate list if one or both of the constituent units are part of a pair with a higher MI value. Pairs that span word boundaries are also eliminated from the list. Remaining candidate pairs v w are replaced in a training corpus by single units v-w. The process for determining candidate pairs can be repeated until a desired number of fragments is obtained. Examples of fragments generated by the mutual information process described above are /-k-ih-ng/ (the syllable “-king”), /ih-n-t-ax-r/ (the syllable “inter-”), /ih-z/ (the word “is”) and /ae-k-ch-uw-ax-l-iy/ (the word “actually”).

Voice search engine 206 accesses index 220 in order to determine if the speech input includes a match in content 222 and/or 224. The lattice generated by voice search engine 206 based on the speech input can be a phonetic sequence or a grammar of alternative sequences. During matching, lattice paths that match or closely correspond to the speech input are identified and a probability is calculated based on the recognition scores in the associated lattice. The hypotheses identified are then output by voice search engine 206 as potential matches.

As mentioned, the speech input can be a grammar corresponding to alternatives that define multiple phonetic possibilities. In one embodiment, the grammar query can be represented as a weighted finite-state network. The grammar may also be represented by a context-free grammar, a unified language model, N-gram model and/or a prefix tree, for example.

In each of these situations, nodes can represent possible transitions between phonetic word fragments and paths between nodes can represent the phonetic word fragments. Alternatively, nodes can represent the phonetic word fragments themselves. Additionally, complex expressions such as telephone numbers and dates can be searched based on an input grammar defining these expressions. Other alternatives can also be searched using a grammar as the query, for example, speech input stating “Paul's address”, where alternatives are in parentheses, “Paul's (address|number)”.

In a further embodiment, filtering can applied to the speech input before searching is performed to remove command information. For instance, speech input comprising “find Paul's address”, “show me Paul's address”, or “search Paul's address” would each yield the same query “Paul's address”, where “find”, “show me” and “search” would not be used in pattern matching. Such filtering can be based on semantic information included with the results received from the speech recognizer 200, 208.

It is also worth noting that a hybrid approach to searching can also be used. In a hybrid approach, phonetic fragment search can be used for queries that have a large number of phones, for example seven or greater phones. For short phones, a word-based search can be used.

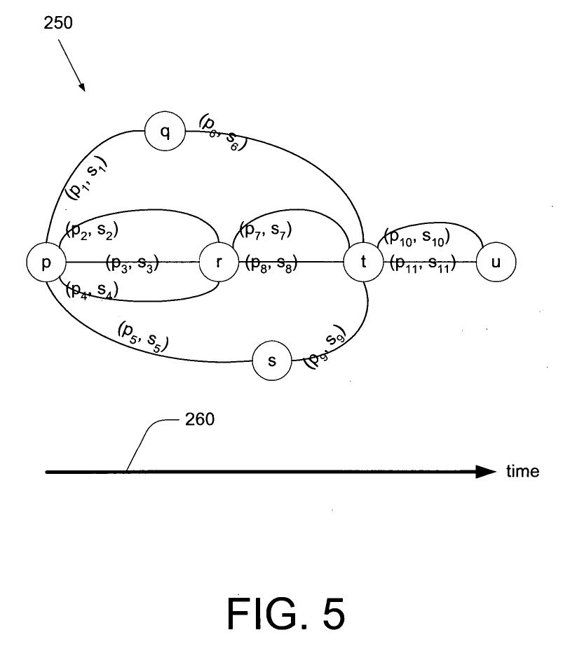

FIG. 5 illustrates an exemplary lattice 250 with nodes p-u and paths between the nodes. Each node has an associated time value or span relative to a timeline 260. Each path from one node to an adjacent node represents a phonetic word fragment (denoted by pₙ) and includes an associated score (denoted by sₙ) representing the likelihood of the path's hypothesis given the corresponding audio segment. A collection of phoneme hypotheses form the phonetic word fragments and paths from a phoneme hypothesis in one fragment to a phoneme hypothesis in another fragment are provided in the lattice and form a transition from one fragment to another fragment.

For example, the score of the path from node p to node q is represented as s₁. If a query matches node r, paths associated with scores s₇ and s₈ will be explored to node t to see if any paths match. Then, paths associated with scores s₁₀ and s₁₁ will be explored to node u. If the paths reach the end of the query, a match is determined. The associated scores along the paths are then added to calculate a hypothesis score. To speed the search process, paths need not be explored if matches share identical or near identical time boundaries.

The result of the search operation is a list of hypotheses (W, tₛ, tₑ, P(W tₛ tₑ|O) that match the query string W in a time range from tₛ to tₑ. A probability P(W tₛ tₑ|O), known as the “posterior probability” is a measure of the closeness of the match. W is represented by a phoneme sequence and O denotes the acoustic observation expressed as a sequence of feature vectors ot. Summing the probabilities of all paths that contain the query string W from tₛ to tₑ yields the following equation:

$$P ( {Wt}_{s} {t}_{e} \vert O ) = \frac{{\sum }_{{W}_{-} , {W}_{+}} p ( {Ot}_{s} {t}_{e} \vert {W}_{-} {WW}_{+} ) P ( {W}_{-} {WW}_{+} )}{{\sum }_{W} p ( O \vert {W}^{′} ) P ( {W}^{′} )}$$

Here, W₋ and W₊ denote any word sequences before tₛ and after tₑ, respectively and W′ is any word sequence. Furthermore, the value p(Otₛtₑ|W₋WW₊) is represented as:
p(Otₛtₑ|W₋WW₊)=p(o _{. . . t}_{ₛ}|W₋)p(oₜ_{ₛ} _{. . . t}_{ₑ}|W)p(oₜ_{ₑ} _{. . . T}|W₊)

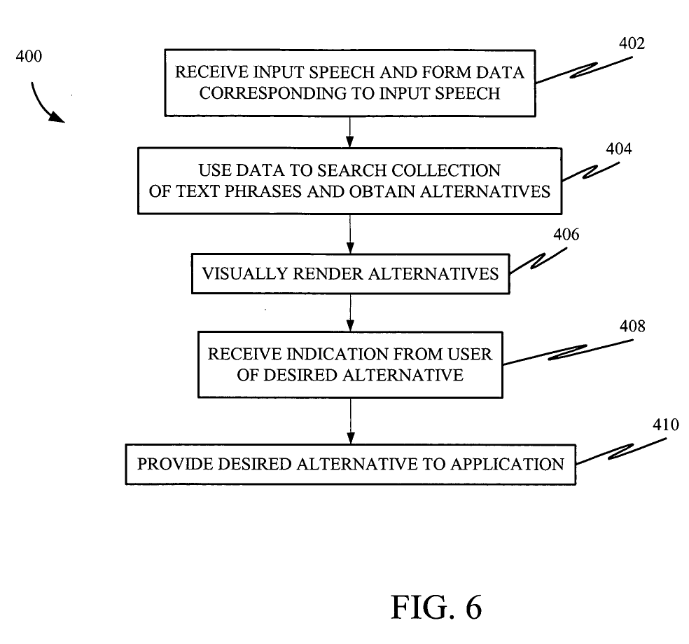

Using speech input to form queries with visual rendering of alternatives and selection therefrom provides a very easy and efficient manner in which to enter desired data for any computing device, and particularly, a mobile device for the reasons mentioned in the Background section. FIG. 6 illustrates a method 400 of providing input into a computer forming another aspect of the present invention. Method 400 includes a step 402 that entails receiving input speech from a user and providing a pattern corresponding to the input speech. At step 404, the pattern is used to search a collection of text phrases (each phrase being one or more characters) to identify one or more text phrases from the collection having a relation to the pattern.

At step 406, the one or more text phrases are visually rendered to the user. FIG. 1 illustrates an exemplary user interface 450 rendered to the user having a list of alternatives 452. (In this example, the user has provided speech input corresponding to a name of a person for scheduling a conference. The search was through the “contacts” database stored on the mobile device 30.) An indication is received from the user pertaining to one of the rendered text phrases at step 408. The indication can be provided from any form of input device, commonly a pointing device such as a stylus, mouse, joystick or the like. However, it should be understood that step 406 also includes audible indications of the desired text phrase. For instance, the rendered list of text phrases can include an identifier for each text phrase. By audibly indicating the identifier, the desired text phrase can be identified.

Having indicated which text phrase is desired at step 408, the desired text phrase can be inserted provided to an application for further processing at step 410. Typically, this includes inserting the selected phrase in a field of a form being visually rendered on the computing device. In the example of FIG. 1, the selected name will be inserted in the “Attendees” field.

The combined use of speech input and selection of visually rendered alternatives provides an efficient method for users to access information, since the user can provide a semantically rich query audibly in a single sentence or phrase without worrying about the exact order of words grammatical correctness of the phrase. The speech input is not simply converted to text and used by the application being executed on the mobile device, but rather is used to form a query to search known content on the mobile device having such or similar words. The amount of content that is searched can now be much more comprehensive since it need not all be rendered to the user. Rather, the content ascertained to be relevant to the speech input is rendered in a list of alternatives, through a visual medium. The user can easily scan the list of alternatives and choose the most appropriate alternative.

Although the present invention has been described with reference to preferred embodiments, workers skilled in the art will recognize that changes may be made in form and detail without departing from the spirit and scope of the invention.

What is claimed is:

1. A computer-readable medium having computer-executable instructions for providing input data into a computer, the instructions comprising:
an audio capture module adapted to provide data indicative of input speech;
a voice search server adapted to receive the data from the audio capture module, the voice search server using the data to search a collection of phrases and identifying one or more phrases from the collection having a relation to the data; and
a module for visually rendering the one or more phrases on the computer and receiving an indication from the user of a selected phrase.

2. The computer-readable medium of claim 1 wherein the voice search server is adapted to filter the data to remove at least one word not searched in the collection.

3. The computer-readable medium of claim 2 wherein the voice search server is adapted to remove at least one word indicative of a command.

4. The computer-readable medium of claim 1 wherein the voice search server is adapted to add alternatives for at least one word in the data.

5. The computer-readable medium of claim 1 wherein the voice search server includes a lattice generator adapted to form a phonetic lattice for the input speech and is adapted to use the data to search the collection by comparing the phonetic lattice for the input speech with phonetic lattices for the collection.

6. A method for providing input into a computer, the method comprising:
receiving input speech from a user and providing data corresponding to the input speech;
using the data to search a collection of phrases and identifying one or more phrases from the collection having a relation to the data;
visually rendering the one or more phrases to the user;
receiving an indication of selection from the user of one of the phrases; and
providing the selected phrase to an application.

7. The method of claim 6 wherein receiving an indication comprises operating a pointing device.

8. The method of claim 6 wherein receiving an indication comprises receiving an audible indication.

9. The method of claim 6 wherein providing the selected phrase comprises inserting the selected phrase in a field of a form rendered on the computer.

10. The method of claim 6 and further comprising filtering the data to remove at least one word not searched in the collection.

11. The method of claim 10 wherein filtering comprises removing at least one word indicative of a command.

12. The method of claim 6 and further comprising adding alternatives for at least one word in the data.

13. The method of claim 6 wherein providing data includes forming a phonetic lattice for the input speech and using the data to search the collection includes comparing the phonetic lattice for the input speech with phonetic lattices for the collection.

14. A mobile computing device comprising:
a store for storing a collection of phrases;
an audio capture module adapted to provide data indicative of input speech;
a voice search server adapted to receive the data from the audio capture module, the voice search server using the data to search the collection of phrases and identifying one or more phrases from the collection having a relation to the data; and
a display/input module for visually rendering the one or more phrases on the computer and receiving an indication from the user of a selected phrase.

15. The mobile computing device of claim 14 wherein the voice search server is adapted to filter the data to remove at least one word not searched in the collection.

16. The mobile computing device of claim 15 wherein the voice search server is adapted to remove at least one word indicative of a command.

17. The mobile computing device of claim 14 wherein the voice search server is adapted to add alternatives for at least one word in the data.

18. The mobile computing device of claim 14 wherein the voice search server includes a lattice generator adapted to form a phonetic lattice for the input speech and is adapted to use the data to search the collection by comparing the phonetic lattice for the input speech with phonetic lattices for the collection.
